(19) United States
(12) Patent Application Publication
(10) Pub. No.: US 2017/0174171 A1
(43) Pub. Date: Jun. 22, 2017

(54) SUPPORT SURFACE FOR PRIMARY AIRBAG IN VEHICLE

(71) Applicants: Hyundai America Technical Center, Inc, Superior Township, MI (US); Hyundai Motor Company, Seoul (KR); Kia Motors Corporation, Seoul (KR)

(72) Inventors: Nathaniel Dennis, Grand Blanc, MI (US); Michael Guerrero, Ann Arbor, MI (US); Ravi Tangirala, South Lyon, MI (US); Kapil S. Butala, Novi, MI (US)

(21) Appl. No.: 14/978,981

(22) Filed: Dec. 22, 2015

(51) Int. Cl. B60R 21/233; B60R 21/2338; B60R 21/206; B60R 21/0136; B60R 21/203

(52) U.S. Cl. CPC B60R 21/233; B60R 21/0136; B60R 21/203; B60R 21/206; B60R 21/2338; B60R 2021/23169

(57) ABSTRACT

An apparatus includes: a deployable support surface installed in a front, driver-side section of a vehicle and configured to project outwardly from the front, driver-side section of the vehicle upon deployment in response to a collision being sensed at the vehicle. When the support surface is deployed, the deployed support surface is positioned substantially behind a deployed primary driver-side airbag and substantially outside of a region of a steering wheel, from a perspective of a driver, and positioned to support an upper body portion of the driver when a collision causing forward and lateral motion of the driver occurs.

BACKGROUND

(a) Technical Field

The present disclosure relates generally to vehicular safety, and more particularly, to a support surface for a primary airbag in a vehicle.

(b) Background Art

Crash tests are a form of destructive testing usually performed in order to ensure safe design standards for various modes of transportation including, primarily, vehicles. There are different types of crash testing—administered in the United States by the National Highway Transportation Safety Administration (NHTSA)—for evaluating different aspects of a vehicle's crashworthiness. The most traditional crash test is known as a “frontal-impact crash test,” whereby a vehicle is driven to collide head-on with a barrier, such as a concrete wall. FIG. 1A illustrates an example frontal-impact crash test, in which the angle of impact directly opposes the direction in which the vehicle 100 travels. In this case, a load generated by colliding with the barrier 110 is experienced throughout the entire front end of the vehicle 100. Meanwhile, in “small overlap crash tests,” only part of the front end of a vehicle impacts a barrier.

Recently, the NHTSA proposed a new “oblique frontal crash test,” where a stationary vehicle is stuck by a barrier (e.g., Oblique Movable Deformable Barrier (OMDB)) at an angle of 15° with an overlap of 35%. For instance, FIG. 1B illustrates an example of oblique frontal crash test, in which a moving barrier 110 collides with the stationary vehicle 100 (impact angle 15° and overlap 35%). An “oblique” collision, as shown in FIG. 1B, can occur whenever a vehicle impacts another object at an angle from the vehicle's direction of travel (i.e., a non-frontal-impact-type collision), such as an errant vehicle veering into oncoming traffic and striking another car.

Notably, in oblique frontal collisions, where the primary loading is not experienced throughout the entire front end of the vehicle, the lateral acceleration of the collision will cause an occupant (e.g., driver, passenger, etc.) to move toward the Principal Direction of Force (PDOF), causing both forward and lateral motion of the driver. If the PDOF is far enough off-center, an occupant may load the traditional frontal restraints (e.g., airbag system) in a manner not represented in current regulatory testing. Indeed, recent oblique collision testing has shown that a primary frontal airbag system alone does not adequately protect an occupant moving simultaneously in forward and lateral directions, resulting in the occupant's head sliding off the primary frontal airbag, or moving through an outer edge of the airbag (where cushion coverage is minimal), and striking the dash panel, A-pillar or door trim. Thus, traditional frontal restraints may not provide a sufficient level of protection for the occupant in the event of an oblique frontal collision, as they would if loaded in a more traditional regulatory loading condition, such as a head-on collision.

### SUMMARY OF THE DISCLOSURE

The present disclosure provides a secondary deployable surface which acts as a support surface for a primary (i.e., traditional) front airbag system, so a primary airbag can provide enhanced support for a vehicle loaded in a manner such as the oblique collision shown in FIG. 1B. The secondary support surface can be located behind the primary driver-side airbag, and outside of a region of the steering wheel, in order to effectively augment the protective area of the primary airbag, which is particularly helpful in the event that a collision causes forward and lateral motion of a vehicle occupant.

According to embodiments of the present disclosure, an apparatus includes: a deployable support surface installed in a front, driver-side section of a vehicle and configured to project outwardly from the front, driver-side section of the vehicle upon deployment in response to a collision being sensed at the vehicle. When the support surface is deployed, the deployed support surface is positioned substantially behind a deployed primary driver-side airbag and substantially outside of a region of a steering wheel, from a perspective of a driver, and positioned to support an upper body portion of the driver when a collision causing forward and lateral motion of the driver occurs.

The support surface may include an airbag. The support surface may also include a knee airbag extension portion, which extends from a knee airbag installed in the vehicle when the support surface is deployed.

The knee airbag extension portion may extend upwardly from the knee airbag when the support surface is deployed. Further, the knee airbag extension portion may extend upwardly from at least one of an upper-left portion and an upper-right portion of the knee airbag when the support surface is deployed. Thus, when the collision causing forward and lateral motion of the driver occurs, the knee airbag extension portion may support the upper body portion of the driver, and the knee airbag may support a lower body portion of the driver.

The knee airbag extension portion and the knee airbag may be formed to share a single, substantially continuous fluid chamber. Alternatively, the knee airbag extension portion and the knee airbag may be formed to have individual fluid chambers, respectively, substantially separate from one another, including a knee airbag extension portion chamber and a knee airbag chamber. In this regard, one or more dividing members may be disposed in an interior of the airbag substantially separating the knee airbag extension portion chamber from the knee airbag chamber. Also, the knee airbag extension portion chamber and the knee airbag chamber may be formed to have one or more of: different pressure levels, different deployment times, and different fluid fill times. The knee airbag extension portion and the knee airbag may be formed such that, during deployment of the support surface, the knee airbag chamber is filled with fluid before the knee airbag extension portion chamber is filled with fluid.

Fluid flow between the knee airbag extension portion chamber and the knee airbag chamber may occur through a fluid flow control interface arranged in an interior of the airbag. The fluid may flow from the knee airbag chamber to the knee airbag extension portion chamber through the fluid flow control interface when a fluid level in the knee airbag chamber reaches a predetermined level. Also, fluid may flow from the knee airbag chamber to the knee airbag extension portion chamber through the fluid flow control interface when a load on the knee airbag is caused by a lower body portion of the driver.

The fluid flow control interface may include a flap that opens to permit fluid flow from the knee airbag chamber to the knee airbag extension portion chamber. Further, the fluid flow control interface may include a folded portion that unfolds to permit fluid flow from the knee airbag chamber to the knee airbag extension portion chamber. The fluid flow control interface may also include a stitched portion that becomes unstitched to permit fluid flow from the knee airbag chamber to the knee airbag extension portion chamber.

An external tension member may be coupled to first and second locations on an exterior of the airbag controlling outward trajectory of the airbag when the support surface is deployed. In addition, one or more dividing members may be disposed in an interior of the airbag to affect a shape of the airbag. When the collision causing forward and lateral motion of the driver occurs, the deployed primary driver-side airbag may be sandwiched between the upper body portion of the driver and the deployed support surface. The support surface may also include a non-inflatable surface opposing the driver.

Furthermore, according to embodiments of the present disclosure, a method includes: sensing a collision at a vehicle; deploying a support surface installed in a front, driver-side section of the vehicle in response to sensing the collision, causing the support surface to project outwardly from the front, driver-side section of the vehicle; and deploying a primary driver-side airbag after deployment of the support surface. When the support surface is deployed, the deployed support surface is positioned substantially behind the deployed primary driver-side airbag and substantially outside of a region of a steering wheel, from a perspective of a driver, and positioned to support an upper body portion of the driver when a collision causing forward and lateral motion of the driver occurs.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A and 1B illustrate example collision testing;

FIGS. 2A and 2B illustrate example cross-sectional views of a conventional primary driver-side airbag deployment;

FIGS. 3A and 3B illustrate example cross-sectional views of a primary driver-side airbag deployment reinforced by a support surface;

FIGS. 4A and 4B illustrate example views of a primary driver-side airbag deployment reinforced by a support surface including a knee airbag extension portion;

FIG. 5 illustrates an example uninflated knee airbag and knee airbag extension portion;

FIG. 6 illustrates an example single chamber knee airbag and knee airbag extension portion configuration including a single fluid chamber;

FIG. 7 illustrates an example multi-chamber knee airbag and knee airbag extension portion configuration;

FIGS. 8A-8D illustrate example fluid flow control mechanisms for implementation within the support surface;

FIGS. 9A and 9B illustrate example cross-sectional side views of a support surface including an external tension member; and

FIG. 10 illustrates an example simplified diagrammatic flowchart of the support surface deployment.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

It is understood that the term “vehicle” or “vehicular” or other similar term as used herein is inclusive of motor vehicles, in general, such as passenger automobiles including sports utility vehicles (SUV), buses, trucks, various commercial vehicles, watercraft including a variety of boats and ships, aircraft, and the like, and includes hybrid vehicles, electric vehicles, hybrid electric vehicles, hydrogen-powered vehicles and other alternative fuel vehicles (e.g., fuels derived from resources other than petroleum). As referred to herein, an electric vehicle (EV) is a vehicle that includes, as part of its locomotion capabilities, electrical power derived from a chargeable energy storage device (e.g., one or more rechargeable electrochemical cells or other type of battery). An EV is not limited to an automobile and may include motorcycles, carts, scooters, and the like. Furthermore, a hybrid vehicle is a vehicle that has two or more sources of power, for example both gasoline-based power and electric-based power (e.g., a hybrid electric vehicle (HEV)).

Referring now to embodiments of the present disclosure, the forward and lateral movement of an occupant of a vehicle (e.g., driver) can be better controlled using the support surface disclosed herein. The support surface may be located behind the primary driver-side airbag cushion and outside the area supported by the steering wheel. In this manner, the driver can be better supported in the event of a collision, and in particular, a collision which causes forward and lateral motion of the driver (i.e., an oblique collision). Thus, driver safety can be enhanced in such situations.

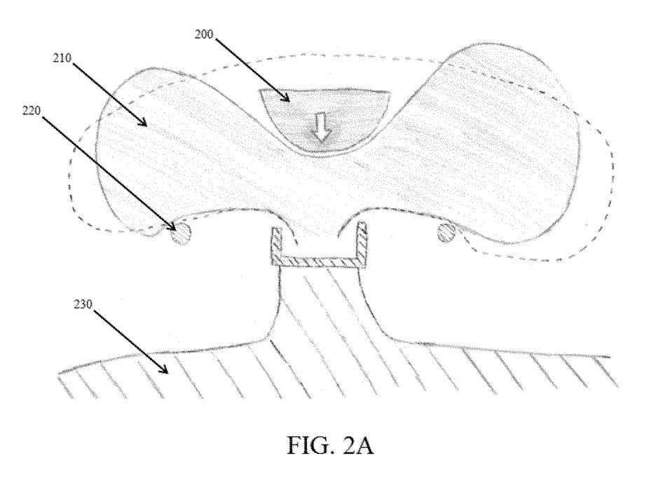

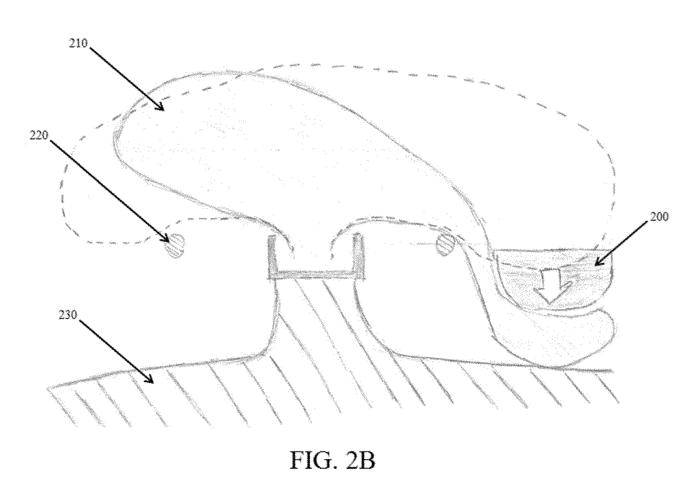

Conventionally, when a collision is sensed at a vehicle (by a standard vehicle collision sensor, for example), a primary driver-side airbag is deployed to provide an energy absorbing surface for a driver, preventing the driver from directly striking objects in the vehicle interior, such as the steering wheel, dashboard, windshield, and the like. FIGS. 2A and 2B illustrate example cross-sectional views of a conventional primary driver-side airbag deployment in which a primary airbag 210 is deployed providing cushion for the driver 200 which moves in a direction due to forces caused by a collision. As is known in the art, the primary airbag 210 may be deployed by rapidly inflating from a compartment within a region of the steering wheel 220 once the vehicle in which the airbag is installed senses a collision. After deployment, the upper body of the driver 200 (e.g., head, neck, chest, etc.) may contact the deployed primary airbag 210 as the driver 200 is propelled forward due to the collision. The airbag 210 provides a cushioned surface between the driver 200 and the steering wheel 220, the dashboard 230, and the like.

The body of the driver 200 then causes the inflated primary airbag 210 to deform from its natural (i.e., non-deformed) inflated shape (shown by dashed lines in FIGS. 2A and 2B). As shown in FIG. 2A, a head-on collision causes the driver 200 to move in a substantially forward direction, e.g., toward a region of the steering wheel 220. Traditional driver airbags are designed for primary loading to occur between the confines of the steering wheel 220, e.g., at the center of the airbag. In such situation, the primary driver-side airbag 210 typically provides ample support for the driver 200 and sufficiently protects the driver 200 from striking an object within the interior of the vehicle.

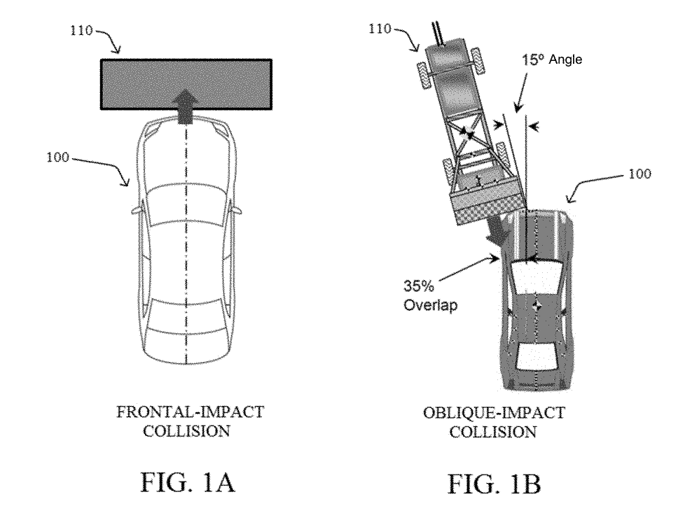

As shown in FIG. 2B, on the other hand, an oblique collision—in which the vehicle collides with another object at an angle from the direction in which the vehicle is travelling (e.g., see FIG. 1B)—causes the driver 200 to move in forward and lateral directions, e.g., toward an area of the dashboard 230 outside of the steering wheel 220. In such situation, the primary driver-side airbag 210 alone does not provide sufficient support for the driver 200 since only an outer periphery of the airbag 210 supports the body of the driver 200 (less support is provided at the outer periphery of the airbag 210 than at a middle portion of the airbag 210). When a load is applied to the driver airbag 220 outside of the area supported by the steering wheel 220, the airbag 220 allows more forward displacement to occur. Consequently, if forces caused by the collision are severe, the upper body (e.g., head, neck, chest, etc.) of the driver 200 may travel through the primary airbag 210 and strike the dashboard 230. Or, the upper body of the driver 200 may slide off the airbag 210 and strike the dashboard 230 directly.

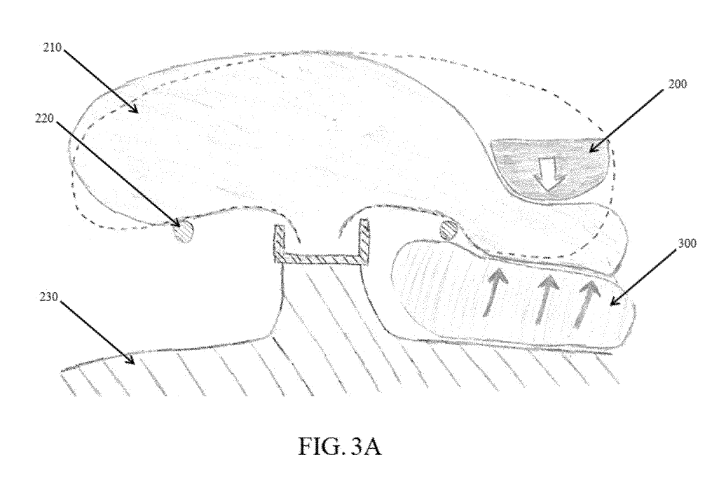

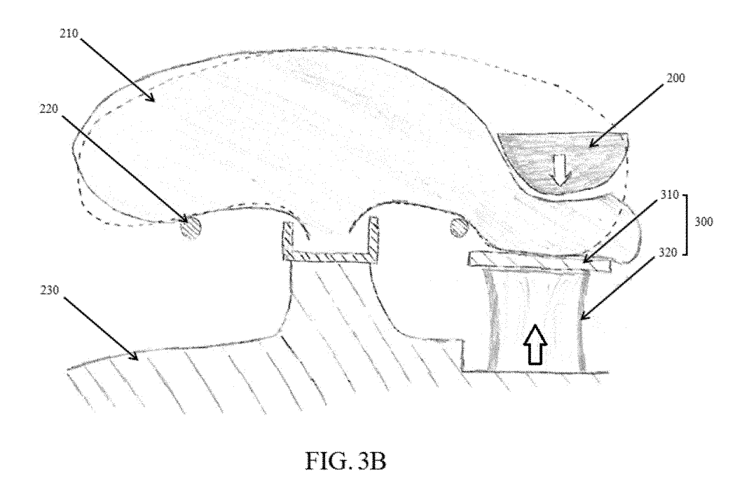

FIGS. 3A and 3B illustrate example cross-sectional views of a primary driver-side airbag deployment reinforced by a support surface. As shown in FIGS. 3A and 3B, a support surface 300 may be installed in a front, driver-side section of the vehicle (e.g., the dashboard 230) and configured to project outwardly from the front, driver-side section of the vehicle upon deployment in response to a collision being sensed at the vehicle. The support surface 300 may be deployed from behind the primary driver-side airbag 210 (from the perspective of the driver), such that the deployed primary airbag 210 is sandwiched between the upper body portion of the driver 200 and the deployed support surface 300. Furthermore, the support surface may be positioned substantially outside of a region of the steering wheel 220; that is, a majority of the deployed support surface 300 may be positioned outside of the region of the steering wheel 220. As a result, the driver 200, and particularly the upper body of the driver 200, can be better supported in the event that a collision causes the driver 200 to move in a forward direction, as well as a lateral direction, e.g., to the right or left of the steering wheel 220.

As shown in FIG. 3A, the support surface 300 may include an airbag (i.e., “secondary airbag”) that inflates upon deployment in response to a collision being sensed at the vehicle. The secondary airbag may be positioned behind the primary airbag 210 and thereby act as a secondary support to the primary driver-side airbag 210. The secondary airbag may be variously configured. For example, in one configuration, the secondary airbag may be a stand-alone airbag mounted in the dashboard 230 behind the primary airbag 210 and outside of the region of the steering wheel 220. In another configuration, the secondary airbag may include a knee airbag extension portion, which extends from a knee airbag installed in the vehicle when the support surface 300 is deployed. This configuration, in particular, is explained in further detail below.

Alternatively, the support surface 300 may include a deployable non-inflatable surface, as shown in FIG. 3B. In this respect, the support surface 300 may include a rigid or semi-rigid surface 310 that opposes the driver 200 upon deployment and provides a secondary support to the primary driver-side airbag 210 (in a manner similar to the secondary airbag shown in FIG. 3A). The surface 310 may be outwardly projected upon deployment by means of support members 320 (e.g., rods, bars, shafts, etc.) or by means of an airbag (not shown). In either arrangement shown in FIG. 3A or FIG. 3B, the support surface 300 protects the driver 200 from impact with the dashboard 230, steering wheel 220, or the like, in the event of a collision causing forward and lateral motion of the driver, by providing secondary support along a periphery of the primary driver-side airbag 210. Thus, the protective area of the primary airbag 210 is effectively increased since the driver 200 can be safely restrained even at the outer edge of the primary airbag (which is supported by the support surface 300).

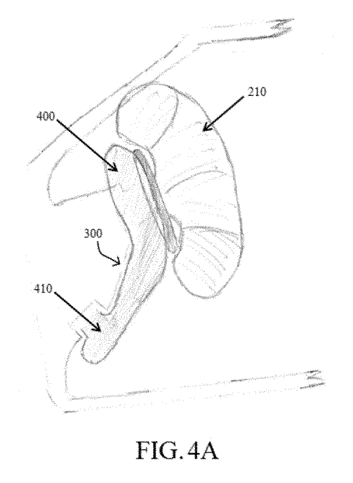

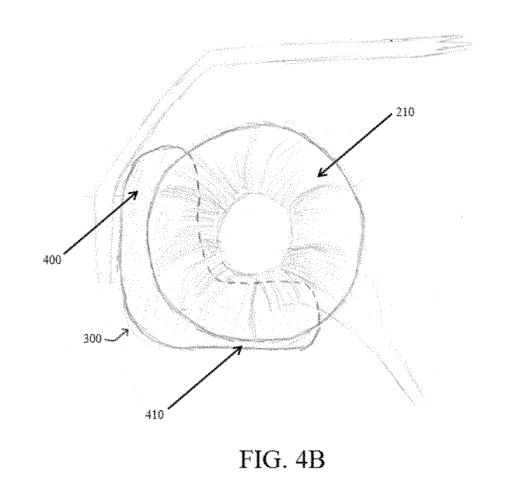

FIGS. 4A and 4B illustrate example views of a primary driver-side airbag deployment reinforced by a support surface including a knee airbag extension portion. FIG. 4A shows a side view of the primary driver-side airbag 210 and the support surface 300 in which a knee airbag extension portion 400 extends from a knee airbag 410 installed in the vehicle when the support surface is deployed. As illustrated, the knee airbag extension portion 400 can extend upwardly from the knee airbag 410 when the support surface 300 is deployed. The knee airbag extension portion 410 may therefore support the upper body of the driver 200, while the knee airbag 410 supports the lower body of the driver 200, particularly in the event of a collision causing forward and lateral motion of the driver 200.

FIG. 4B shows a front view of the primary driver-side airbag 210 and support surface 300 including the knee airbag extension portion 400 extending from the knee airbag 410 when deployed. As illustrated, the knee airbag extension portion 400 extends upwardly from the knee airbag 410 when the support surface 300 is deployed. The knee airbag extension portion 400 may extend upwardly from at least one of an upper-left portion and an upper-right portion of the knee airbag 410.

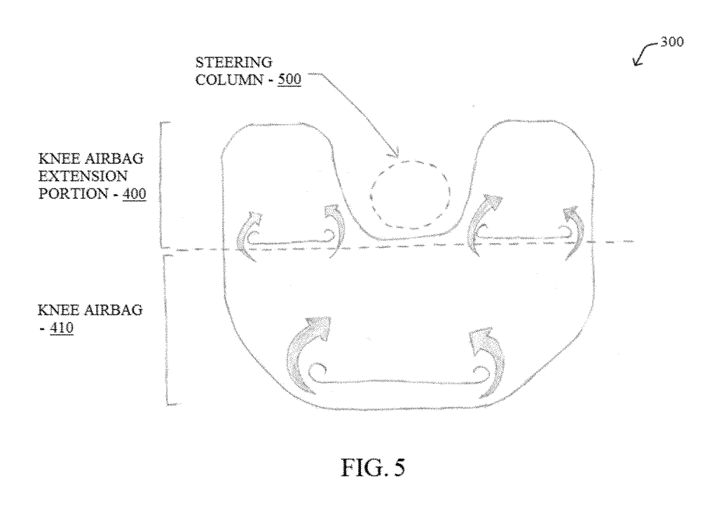

FIG. 5 illustrates an example uninflated knee airbag and knee airbag extension portion. As shown in FIG. 5, the support surface 300 (i.e., “secondary airbag”) includes a conventional knee airbag 410 from which the knee airbag extension portion 400 extends, prior to deployment (i.e., inflation). In FIG. 5, the knee airbag extension portion 400 extends upwardly from both of the upper-left portion and the upper-right portion of the knee airbag 410, though the knee airbag extension portion 400 may extend from only one of the upper-left portion and the upper-right portion of the knee airbag 410 (e.g., see FIG. 4B). Therefore, the knee airbag extension portion 400 may inflate on either side, or both sides, of the steering column 500. Moreover, the knee airbag 410 may include one or more dividing members disposed in an interior thereof to control fluid flow within the airbag and allow the knee airbag 410 to inflate prior to inflation of the knee airbag extension portion 400, as described in further detail below.

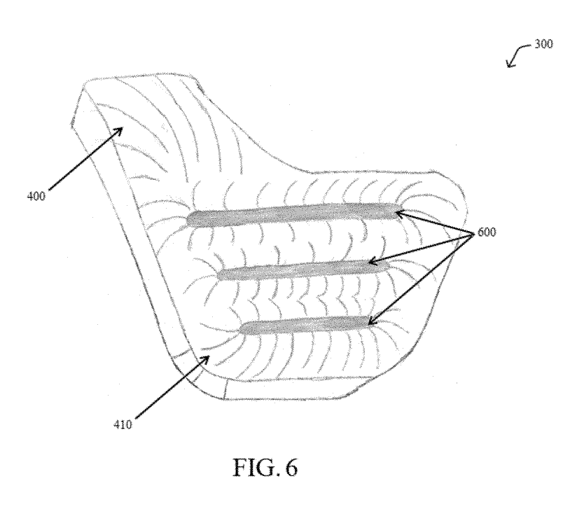

FIG. 6 illustrates an example single chamber knee airbag and knee airbag extension portion configuration including a single fluid chamber. As shown in FIG. 6, the support surface 300 may include a knee airbag 410 installed in a vehicle and a knee airbag extension portion 400 extending therefrom (e.g., as shown in FIGS. 4A and 4B). In FIG. 6, the knee airbag extension portion 400 and the knee airbag 410 are formed to share a single, substantially continuous fluid (e.g., air) chamber. Thus, the knee airbag extension portion 400 and the knee airbag 410 may be inflated contemporaneously (or nearly contemporaneously), as air fills the entire single chamber and inflates both of the knee airbag extension portion 400 and the knee airbag 410 at the same time.

Additionally, one or more dividing members 600 may be disposed in an interior of the airbag to affect or control a shape of the airbag. The dividing members 600 may include, for example, tethers, baffles, or the like. However, the airbag need not include any dividing members (e.g., “zero tethers”).

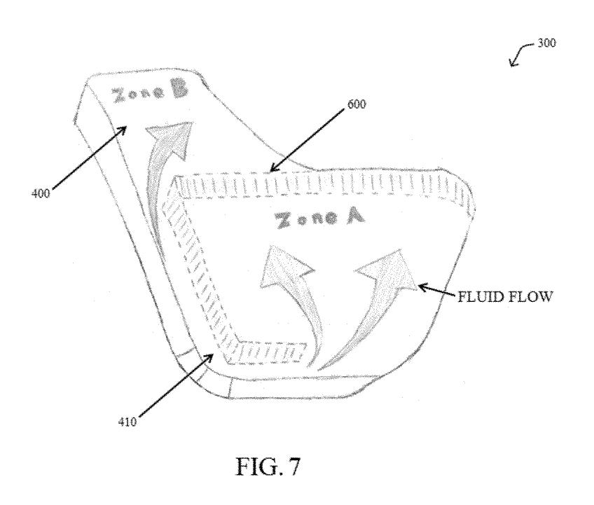

FIG. 7 illustrates an example multi-chamber knee airbag and knee airbag extension portion configuration. As shown in FIG. 7, the support surface 300 may include a knee airbag 410 installed in a vehicle and a knee airbag extension portion 400 extending therefrom (e.g., as shown in FIGS. 4A and 4B). Notably, the outward appearance and shape of the inflated support surface 300 of FIG. 7 is equivalent to that of the inflated support surface 300 of FIG. 6. However, in FIG. 7, the knee airbag extension portion 400 and the knee airbag 410 are formed to have individual fluid chambers, respectively, substantially separate from one another, including a knee airbag chamber (i.e., “Zone A”) and a knee airbag extension portion chamber (i.e., “Zone B”). That is, the knee airbag 410 and the knee airbag extension portion 400 correspond to the knee airbag chamber A and the knee airbag extension portion chamber B, respectively. In general, a multi-chamber configuration allows for the knee airbag chamber to be filled with fluid before the knee airbag extension portion chamber is filled with fluid, during deployment of the support surface 300 (though the multi-chamber design is not limited to such operation). The knee airbag chamber and knee airbag extension portion chamber may be separated using, for example, one or more dividing members 600 disposed in an interior of the airbag.

Because the knee airbag chamber and knee airbag extension portion chamber are internally separated from one another, the knee airbag extension portion 400 and the knee airbag 410 may exhibit different properties, as desired. Thus, performance tuning of the knee airbag extension portion 400, for example, would have minimal effect on the performance of the knee airbag 410. In this regard, the knee airbag extension portion chamber and the knee airbag chamber may be formed to have different pressure levels. Additionally, the knee airbag extension portion chamber and the knee airbag chamber may be formed to have different deployment times (i.e., a time at which the respective chamber is deployed) and different fluid fill times (i.e., a time taken to inflate the respective chamber). As a result, usage of inflator gas—a typically limited resource—can be optimized.

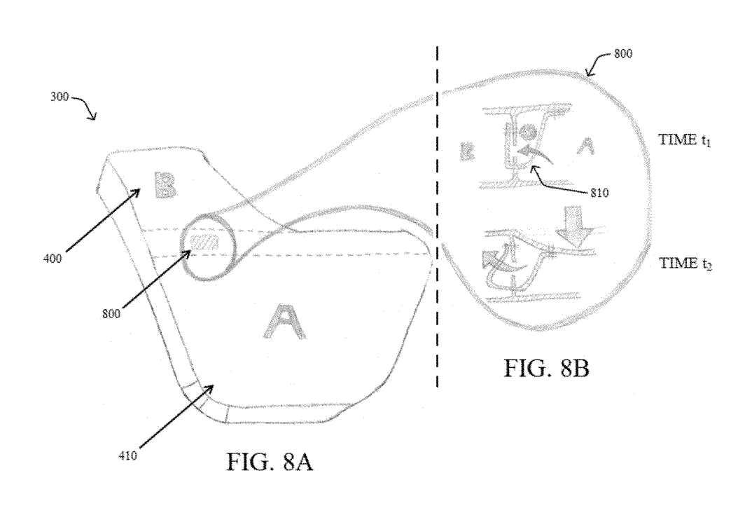

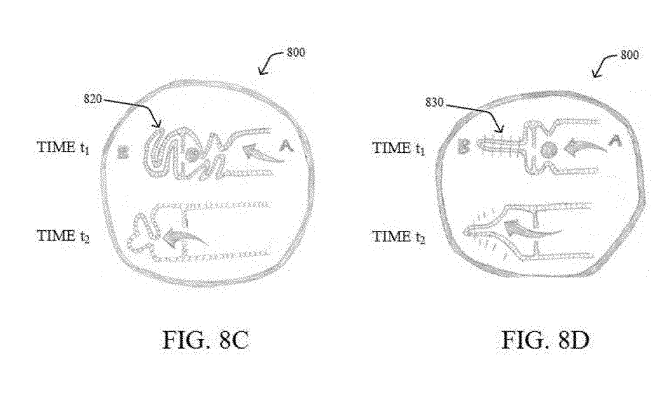

FIGS. 8A-8D illustrate example fluid flow control mechanisms for implementation within the support surface. As shown in FIG. 8A, the support surface 300 may include a knee airbag 410 and a knee airbag extension portion 400 extending therefrom (e.g., as shown in FIGS. 4A and 4B). Similar to the support surface 300 of FIG. 7, in FIG. 8A, the knee airbag extension portion 400 and the knee airbag 410 are formed to have individual fluid chambers, respectively, substantially separate from one another, including a knee airbag chamber (i.e., “Zone A” or ‘A’) and a knee airbag extension portion chamber (i.e., “Zone B” or ‘B’).

In general, the multi-chamber configuration allows for the knee airbag chamber A to be filled with fluid before the knee airbag extension portion chamber B is filled with fluid, during deployment of the support surface 300. The fluid may flow from the knee airbag chamber A to the knee airbag extension portion B through a fluid flow control interface 800 arranged in an interior of the airbag. The fluid flow control interface 800 may be variously configured to control the flow of fluid from the knee airbag chamber A to the knee airbag extension portion chamber B. That is, the fluid flow control interface 800 can control the deployment and trajectory of the knee airbag 410 and the knee airbag extension portion 400. Thus, the fluid flow control interface 800 can be designed to achieve a desired performance (e.g., deployment time, fluid fill time, pressure level, etc.) for each of the knee airbag extension portion 400 and the knee airbag 410, respectively.

As an example, fluid may flow from the knee airbag chamber A to the knee airbag extension portion chamber B through the fluid flow control interface 800 when a fluid level in the knee airbag chamber A reaches a predetermined level. Also, fluid may flow from the knee airbag chamber A to the knee airbag extension portion chamber B through the fluid flow control interface 800 when a load is sensed at the knee airbag 410 (e.g., caused by a lower body portion of the driver).

The fluid flow control interface 800 may comprise a variety of flow control mechanisms which permit fluid to flow from the knee airbag chamber A to the knee airbag extension portion chamber B once a particular threshold event occurs. For instance, as shown in FIG. 8B, the fluid flow control interface 800 may include a tether flap 810 that opens to permit fluid flow from the knee airbag chamber A to the knee airbag extension portion chamber B. As illustrated, the flap 810 of the fluid flow control interface 800 may be closed at time t₁ and open at time t₂. The flap 810 may open to permit the fluid flow upon occurrence of a threshold event. For instance, the flap 810 may open once a load is sensed at the knee airbag 410 (e.g., caused by a lower body portion of the driver), or once a fluid level in the knee airbag chamber A reaches a predetermined level.

Additionally, as shown in FIG. 8C, the fluid flow control interface 800 may include a folded portion 820 that unfolds to permit fluid flow from the knee airbag chamber A to the knee airbag extension portion chamber B. As illustrated, the folded portion 820 of the fluid flow control interface 800 may be folded at time t₁ and unfold at time t₂. The folded portion 820 can be arranged in a manner so as to become unfolded to permit the fluid flow upon occurrence of a threshold event, such as the knee airbag chamber A becoming fully or nearly fully inflated.

As shown in FIG. 8D, the fluid flow control interface 800 may include a stitched portion 830 (e.g., “tear stitches”) that becomes unstitched to permit fluid flow from the knee airbag chamber A to the knee airbag extension portion chamber B. As illustrated, the stitched portion 830 of the fluid flow control interface 800 may be stitched at time t₁ and the stitches may tear apart at time t₂. The stitched portion 830 can be prepared in a manner so as to tear and permit fluid flow after a predetermined amount of time or after a predetermined pressure level is reached in the knee airbag chamber A.

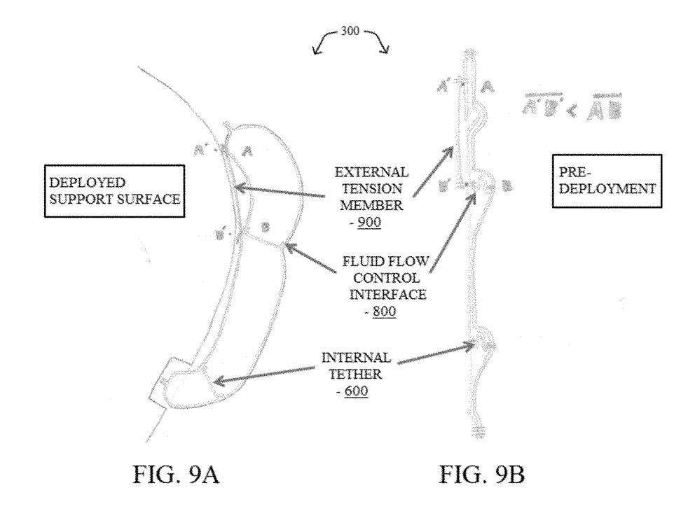

Deployment and trajectory of the knee airbag 410 and the knee airbag extension portion 400 can be further controlled using external tension members. In this regard, FIGS. 9A and 9B illustrate example cross-sectional side views of a support surface including an external tension member. As shown in FIG. 9A, the deployed support surface 300 includes an external tension member 900 coupled to first location A and second location B on an exterior of the airbag of the support surface 300 (i.e., “secondary airbag”). Similarly, FIG. 9B shows a pre-deployment support surface 300 including the external tension member 900 coupled to the first location A and second location B on the exterior of the airbag. The secondary airbags may also include one or more internal dividing members 600 (e.g., tethers, baffles, etc.) and a fluid flow control interface 800 to control fluid flow from the knee airbag 410 to the knee airbag extension portion 400, as explained above.

As illustrated, the distance AB is the distance from first location A to second location B along the airbag. Meanwhile, the distance A′B′ is the distance from first location A to second location B along the tension member 900. In this case, the distance AB is greater than the distance A′B′, which allows the airbag to project outwardly upon deployment while being restrained according to the arrangement of the tension member 900. It should be understood that the greater the difference between AB and A′B′, the further the airbag is permitted to outwardly project (i.e., toward the driver). Accordingly, the external tension member 900 helps to guide the outward trajectory of the airbag when the support surface 300 is deployed.

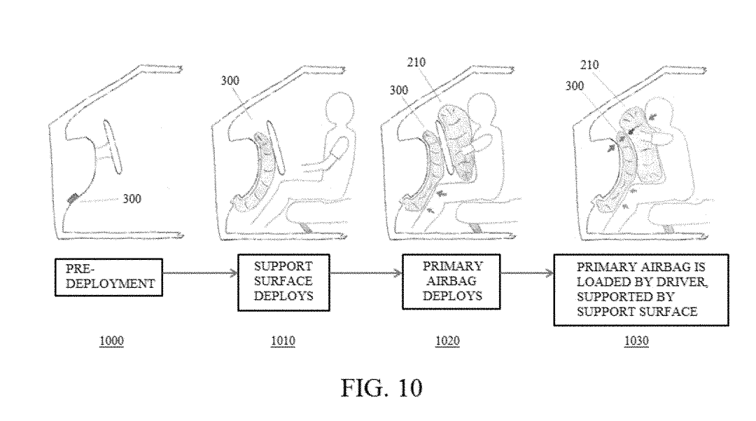

FIG. 10 illustrates an example simplified diagrammatic flowchart of the support surface deployment. The procedure may start at step 1000, and continue to step 1010, where, as described in greater detail above, a support surface can better support a driver of a vehicle in the event of a collision, and in particular, a collision which causes forward and lateral motion of the driver.

At step 1000, all vehicle airbags are in a pre-deployment state, i.e., a collision has not yet occurred. At step 1010, a collision is sensed at the vehicle (e.g., using a collision sensor installed in the vehicle), and in response, the support surface 300 is deployed. The support surface 300 may be configured to include a knee airbag extension portion, for example, as explained above. The knee airbag extension portion can extend upwardly from a knee airbag installed in the vehicle when the support surface 300 is deployed. The support surface may therefore support the upper body of the driver (while the knee airbag supports the lower body of the driver), particularly in the event of a collision causing forward and lateral motion of the driver. Deployment of the knee airbag and the knee airbag extension portion may be staggered, e.g., in the manner described above. Then, at step 1020, the primary driver-side airbag 210 is deployed. The primary airbag 210 may be deployed from within a region of the steering wheel of the vehicle, as is generally known in the art. The primary airbag 210 may be positioned in front of the support surface 300, and thus, the support surface 300 acts as a secondary support to the primary airbag 210. Finally, at step 1030, the driver of the vehicle is propelled forward due to forces caused by the collision. The primary airbag 210 is consequently loaded from absorbing forward forces from the driver. The support surface 300 provides a secondary support to the primary airbag 210, particularly along the periphery thereof. Thus, the protective area of the primary airbag 210 is effectively increased since the driver 200 can be safely restrained even at the outer edge of the primary airbag (which is supported by the support surface 300).

The procedure of FIG. 10 illustratively ends at step 1030. The techniques by which the steps of the procedure may be performed, as well as ancillary procedures and parameters, are described in additional detail above. The control logic for controlling and executing this procedure may be performed by a control unit (i.e., processor and memory) installed in the vehicle.

It should be noted that the steps shown in FIG. 10 are merely examples for illustration, and certain other steps may be included or excluded as desired. Further, the illustrated steps may be modified in any suitable manner in accordance with the scope of the present claims.

Accordingly, the support surface for a primary airbag described herein reduces the risk of upper body injury, and most notably, head injury in the event of a collision forcing a vehicle occupant in a lateral direction (e.g., outside of the steering wheel region). The support surface provides enhanced protection for vehicle occupants by supporting the primary airbag along its outer edge where cushioning is less than at its center. The added cushioning provided by the support surface may protect vehicle occupants in the event of oblique collisions, as well as other collisions such as head-on collisions, rollovers, and so forth.

While there have been shown and described illustrative embodiments that provide for a support surface for a primary airbag, it is to be understood that various other adaptations and modifications may be made within the spirit and scope of the embodiments herein. For example, the embodiments have been primarily shown and described herein with relation to an airbag as a support surface. However, the embodiments in their broader sense are not as limited. Rather, the support surface may include non-inflatable components, as well. Thus, the embodiments may be modified in any suitable manner in accordance with the scope of the present claims.

The foregoing description has been directed to embodiments of the present disclosure. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. An apparatus comprising:
a deployable support surface installed in a front, driver-side section of a vehicle and configured to project outwardly from the front, driver-side section of the vehicle upon deployment in response to a collision being sensed at the vehicle,
wherein, when the support surface is deployed, the deployed support surface is positioned substantially behind a deployed primary driver-side airbag and substantially outside of a region of a steering wheel, from a perspective of a driver, and positioned to support an upper body portion of the driver when a collision causing forward and lateral motion of the driver occurs.

2. The apparatus of claim 1, wherein the support surface includes an airbag.

3. The apparatus of claim 2, wherein the support surface includes a knee airbag extension portion, which extends from a knee airbag installed in the vehicle when the support surface is deployed.

4. The apparatus of claim 3, wherein the knee airbag extension portion extends upwardly from the knee airbag when the support surface is deployed.

5. The apparatus of claim 3, wherein the knee airbag extension portion extends upwardly from at least one of an upper-left portion and an upper-right portion of the knee airbag when the support surface is deployed.

6. The apparatus of claim 3, wherein when the collision causing forward and lateral motion of the driver occurs, the knee airbag extension portion supports the upper body portion of the driver, and the knee airbag supports a lower body portion of the driver.

7. The apparatus of claim 3, wherein the knee airbag extension portion and the knee airbag are formed to share a single, substantially continuous fluid chamber.

8. The apparatus of claim 3, wherein the knee airbag extension portion and the knee airbag are formed to have individual fluid chambers, respectively, substantially separate from one another, including a knee airbag extension portion chamber and a knee airbag chamber.

9. The apparatus of claim 8, wherein one or more dividing members are disposed in an interior of the airbag substantially separating the knee airbag extension portion chamber from the knee airbag chamber.

10. The apparatus of claim 8, wherein the knee airbag extension portion chamber and the knee airbag chamber are formed to have one or more of: different pressure levels, different deployment times, and different fluid fill times.

11. The apparatus of claim 8, wherein the knee airbag extension portion and the knee airbag are formed such that, during deployment of the support surface, the knee airbag chamber is filled with fluid before the knee airbag extension portion chamber is filled with fluid.

12. The apparatus of claim 8, wherein fluid flow between the knee airbag extension portion chamber and the knee airbag chamber occurs through a fluid flow control interface arranged in an interior of the airbag.

13. The apparatus of claim 12, wherein fluid flows from the knee airbag chamber to the knee airbag extension portion chamber through the fluid flow control interface when a fluid level in the knee airbag chamber reaches a predetermined level.

14. The apparatus of claim 12, wherein fluid flows from the knee airbag chamber to the knee airbag extension portion chamber through the fluid flow control interface when a load is sensed at the knee airbag caused by a lower body portion of the driver.

15. The apparatus of claim 12, wherein the fluid flow control interface includes a flap that opens to permit fluid flow from the knee airbag chamber to the knee airbag extension portion chamber.

16. The apparatus of claim 12, wherein the fluid flow control interface includes a folded portion that unfolds to permit fluid flow from the knee airbag chamber to the knee airbag extension portion chamber.

17. The apparatus of claim 12, wherein the fluid flow control interface includes a stitched portion that becomes unstitched to permit fluid flow from the knee airbag chamber to the knee airbag extension portion chamber.

18. The apparatus of claim 2, further comprising an external tension member coupled to first and second locations on an exterior of the airbag controlling outward trajectory of the airbag when the support surface is deployed.

19. The apparatus of claim 2, further comprising one or more dividing members disposed in an interior of the airbag to affect a shape of the airbag.

20. The apparatus of claim 1, wherein when the collision causing forward and lateral motion of the driver occurs, the deployed primary driver-side airbag is sandwiched between the upper body portion of the driver and the deployed support surface.

21. The apparatus of claim 1, wherein the support surface includes a non-inflatable surface opposing the driver.

22. A method comprising:
sensing a collision at a vehicle;
deploying a support surface installed in a front, driver-side section of the vehicle in response to sensing the collision, causing the support surface to project outwardly from the front, driver-side section of the vehicle; and
deploying a primary driver-side airbag after deployment of the support surface,
wherein, when the support surface is deployed, the deployed support surface is positioned substantially behind the deployed primary driver-side airbag and substantially outside of a region of a steering wheel, from a perspective of a driver, and positioned to support an upper body portion of the driver when a collision causing forward and lateral motion of the driver occurs.
